(19) United States
(12) Patent Application Publication
(10) Pub. No.: US 2006/0118421 A1
(43) Pub. Date: Jun. 8, 2006

(54) Electrolytic cell or modified electrolytic cell for the metal recovery its base or floor comprising pyramid-shaped funnels which allow the continuous extraction of sludge from the bottom of the cell, in addition discloses the method to recover the sludge

(76) Inventor: Raul Nibaldo Ibarra Macaya, Antofagasta (CL)

Correspondence Address: MERCHANT & GOULD PC, P.O. BOX 2903, MINNEAPOLIS, MN, 55402-0903, US

(21) Appl. No.: 11/265,829

(22) Filed: Nov. 2, 2005

(30) Foreign Application Priority Data
Nov. 4, 2004 (CL) 2854-2004

(51) Int. Cl. B03C 5/00

(52) U.S. Cl. 204/554

(57) ABSTRACT

The present invention reveals an electrolytic cell or modified electrolytic cell used for the recovery of metals, having a configuration with pyramid-shaped funnels that allows the continuous extraction and removal of anode sludge and slimes through the floor of the cell. The cell comprises the following components: a cell with a rectangular base (1) having pyramid-shaped funnels (2), said pyramid-shaped funnels ending at a circular discharge point (5) followed by a discharge duct (3) having one or more shut-off valves. The invention also reveals details of a method for the continuous extraction and removal of anode sludge and slime, using the new type of electrolytic cell or vessel.

### DESCRIPTION

The present invention relates to a cell or vessel for use in electro-winning or electro-refining, its base or floor comprising pyramid-shaped funnels. The invention makes possible the continuous removal of lead sludge, or anode sludge from the bottom of the cell, in both processes, without using a short-circuiting frame.

### BACKGROUND OF THE INVENTION

The electro-winning process for the removal of metals from aqueous solutions, using insoluble anodes, is a widely used technique for the production of high purity metals, such as copper, zinc, nickel, cobalt, cadmium, and manganese, where the metallic element contained in an aqueous solution, which is derived from mineral leaching, is deposited on the cathode.

The anode used in 14% of electro-winning plants in the world is made of cast lead, while the remaining 86% use laminated anodes made of lead-calcium-tin alloy. On the other hand, permanent cathodes are used in 70% of the electro-winning plants. The operational conditions used in electro-winning of copper and other metals, causes a gradual degradation of the anode, leading to the production of sludge that, due to its higher density, is deposited at the bottom of the cell. The turbulence caused by the inlet flow of electrolyte, leads to the resuspension of the aforementioned sludge, which is mechanically trapped around the cathodes, and consequently said sludge contaminates the surface of the cathodes.

The desired metal to be recovered is electro-deposited on the cathode from a solution, wherein it is usually present as a sulphate, while water is decomposed at the anode generating gaseous oxygen and hydrogen ions (acid) (Wang and Shijie, “Recovering copper using a combination of electrolytic cells”, Journal of Metals, Jun. 2002).

On the other hand, electro-refining is used to recover copper, silver and gold, as well as nickel, and in certain cases lead. The refining of copper is probably the most important aqueous refining process, and it is used when the copper mineral contains high impurity levels, for instance antimony and arsenic, or when it contains silver and gold in sufficient concentrations to justify refining. The anodes are cast from pyro-refined copper or directly from blister copper. The “starting plates” for the cathodes generally comprise electro deposited copper, which become part of the final product. The electrolyte is an acidified solution of copper sulphate.

During electrolysis, copper and other less noble metals contained in the anode dissolve into the electrolyte, while the more noble metals such as gold and silver are not attacked and remain on the anode. Compounds of copper with antimony, arsenic, sulphur and selenium are also not attacked and remain on the anode, and eventually fall to the bottom of the cell to form a solid metallic sludge together with the noble metals, which is known as anode sludge.

Copper deposits on the cathode while the less noble metals, nickel and iron, remain in solution.

Electro-Winning and Electro-Refining Cells

There is a large variety of cell configurations used in electro-winning and literature describes cell designs based on different forms of electrodes. Cell design can be classified into two main groups: vessels with a rectangular base, and cylindrical electrode cells.

The vessels with a smooth rectangular base are the most commonly used type of commercially available cells used in electro-winning and electro-refining, and are cast in one piece using polymeric concrete.

These cells comprise multiple electrode plates positioned in a parallel relationship with alternating anodes and cathodes immersed in an electrolyte, and connected externally to an electric circuit, which includes a power source, and control devices (W. Davenport, J. Jenkins, T. Robinson and G. Karcas. “Electrolytic copper electro-winning”, World 2001 Tank House Operating Data, 31st Annual Hydrometallurgy Meeting of CIMM).

In the electro-winning process, the removal of lead sludge from the cells is currently carried out by emptying the cells and removing the electrolyte and the electrodes. This operation is only possible after electrical insulation of each cell to be desludged. Under optimum conditions, this operation takes between 2 and 4 hours, for a group of 3 cells to be desludged. The disadvantage of this process is that there is no copper production in these cells for large periods of time, with the consequent economic loss. Down time for any system or equipment, must be considered as a loss of profit, whether this occurs for reasons of maintenance or breakdown.

To insulate the cells, a metallic short-circuiting frame is used that requires an electrical current reduction in the entire circuit that contains the cells to be desludged when being installed. After installing the frame, the normal working current is reestablished in the rest of the circuit, while the desludging operation is carried out in the insulated cells. Patent Application CL 2236-1997 reveals a short-circuiting frame that produces no electric arcs during the process of installing the frame on the cells or removing the frame from the cells, which allows the frame to be installed or removed without reducing the current in the circuit for all the cells.

The cleaning operation begins with the removal of the demisting balls, followed by the draining of the clear electrolyte down to a level 15-20 cm above the sludge level. This can be done by pumping or gravity. The anodes and cathodes are removed before or during the draining process, and the final remnants of electrolyte are removed by draining through the sump opening in the bottom of the cell.

Once the electrolyte has been removed, workers can enter into the cell and remove the lead sludge using shovels. The sludge is then filled into a large container which is then removed from the cell using a bridge crane. The fine sludge remaining at the bottom of the cell is flushed into the sump using a high pressure water hose.

Once the cells designated for cleaning have been thoroughly cleaned, they are refilled with fresh electrolyte, new cathodes and anodes are installed, and the current reduction process is repeated to allow the removal of the electrode holders, after which the current is gradually increased until it returns to normal working conditions.

There are several disadvantages to the currently used sludge removal and cleaning process. A bridge crane is required to remove and reposition the electrodes, the process is very labor intensive and there are serious safety problems involved in the handling of toxic residues and possible electrical safety risks to workers

The sludge removal process used in the electro-refining process is different from the electro-winning process. The line or series of cells which is to be desludged is first de-energized, leaving all the cells in the sector without electricity. Each cell in the sector is then desludged and cleaned on an individual basis. The first stage in the process is the draining of the clear electrolyte down to the level over the anode sludge, followed by the removal of the electrodes. When about 1 m³ of electrolyte remains in the cell, this is pumped out using centrifugal pumps. The anodic sludge is stored for later processing.

The electrodes are then reinstalled, and the cell is filled again with electrolyte. This process is repeated with each cell in the sector, after which the cells are re-energized and the production process begins again.

The present invention reveals a cell or vessel for the electrolytic recovery of metals, which incorporates pyramid-shaped funnels in the bottom or floor of the cell that facilitate the movement of anode sludge towards a discharge opening, allowing a continuous evacuation of the sludge, without stopping either the electro-winning or electro-refining processes.

Patent Applications with the same objectives have been filed at the Chilean Department of Industrial Property (DPI), related to the removal of anode sludge or slime, without the use of a short-circuiting frame, and without interrupting the production process. The following documents have been filed at the aforementioned department, but they do not interfere in any way with the solutions proposed in the invention described herein.
Patent Application CL N^{o} 1410-2000 describes a mobile suction machine which moves along the bottom of the cell, to remove part of the accumulated solids.
Patent Application CL N^{o} 987-2002 describes an autonomous mobile suction machine which filters, weighs and packages sludge.
Patent Application CL N^{o} 2806-2002 is similar to the previous application.

Chilean Patent Applications CL 1961-1998, CL 1409-2002, CL 1411-2002 and CL 2733-2002 have also been filed through different channels, but with similar objectives, for an invention that involves the insertion of a separating component in the cell, which separates the bottom of the cell from the rest of the cell, thus eliminating the contamination of the cathodes during the sludge extraction. All these Patent Applications do not interfere in any way with the novelty of the present invention, as no document mentions or describes a cell which contains pyramid-shaped funnels in its base or floor, which allow the continuous removal of anode sludge.

### SUMMARY OF THE INVENTION

The invention described herein has the following objectives: firstly, the new cell or vessel cast completely in one piece of polymeric concrete, with pyramid shaped funnels in its base, has been invented for use in projects to be implemented that involve different operational methods using electrolytic cells or vessels. As a secondary objective, the invention can be used in cells which are currently in operational use in mining plants, wherein a structure is proposed to be incorporated in the existing cells that simulates the scheme of the new cell previously described, which is achieved by the incorporation of pyramid-shaped funnels in the floor inside the cells. Finally, the development of a desludging method for both cases mentioned above is proposed.

### DETAILED DESCRIPTION OF THE INVENTION

Design of a New Cell Type

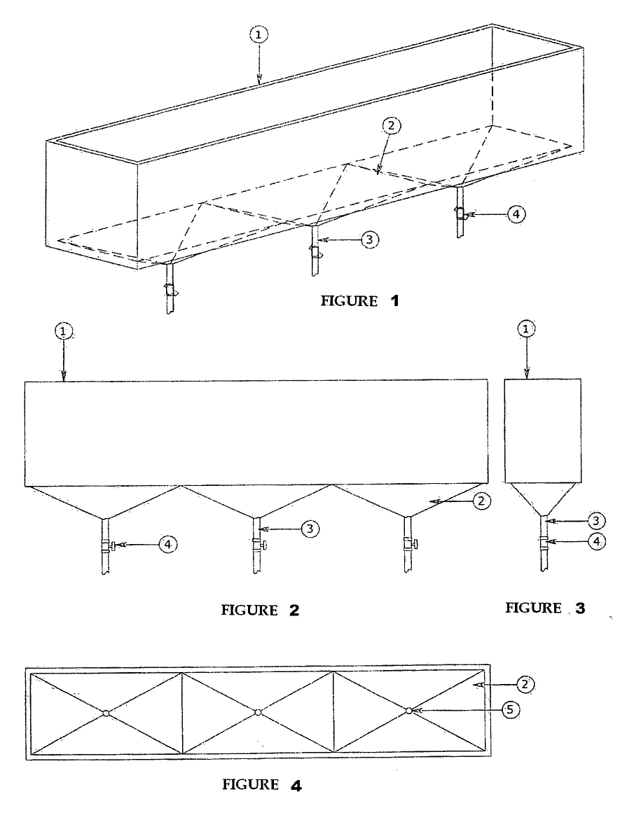

FIG. 1 shows the new cell or vessel unit, which can be cast in polymeric concrete or any other appropriate material, formed by a structure with 4 walls and a rectangular base (1), with a thickness similar to that used in normal cells, which is usually between 80-100 mm, and the base having 3 or more pyramid-shaped funnels (2), each ending at a circular discharge duct with one shut-off valve (4).

FIG. 2 shows the slope of the aforesaid funnels, which allows the deposited solids in the sludge to slide easily down towards the discharge duct (3) having the shut-off valve (4).

FIG. 3 shows a side view of the described cell, with the shut-off valve (4) and the discharge duct (3).

FIG. 4 shows a top view of the cell, showing more in detail the pyramid-shaped funnels (2) and the sludge discharge opening (5) which leads to the discharge duct (3), which is not shown in this figure.

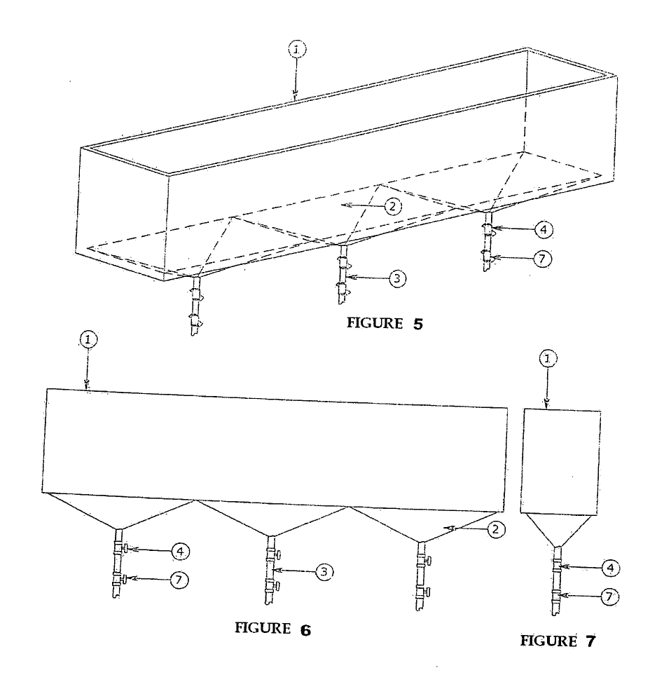

FIG. 5 shows a different embodiment of the present invention, in which two serial valves are positioned along the discharge duct of the new cell or vessel. FIG. 5 shows the cell or vessel built with all its pyramid-shaped funnels (2) ending at the discharge duct (3) having two serial valves (4) and (7).

FIG. 6 shows the slope of the walls of the funnels, with their discharge duct (3) and two valves (4) and (7).

FIG. 7 is a side view of the cell showing both valves (4) and (7).

Modification of Cells or Vessels Currently in Use

The 5,284 polymeric concrete cells currently in use in Chile (Revista Mineria Chilena (Chilean Mining Magazine), September 2004), are cells individually manufactured and cast in one piece. Consequently, it is not technically feasible to modify existing cells, while at the same time the replacement of existing cells cannot be justified in economic terms.

In such circumstances, it is only possible to reproduce the geometric shape of the funnels of the new design inside those existing cells.

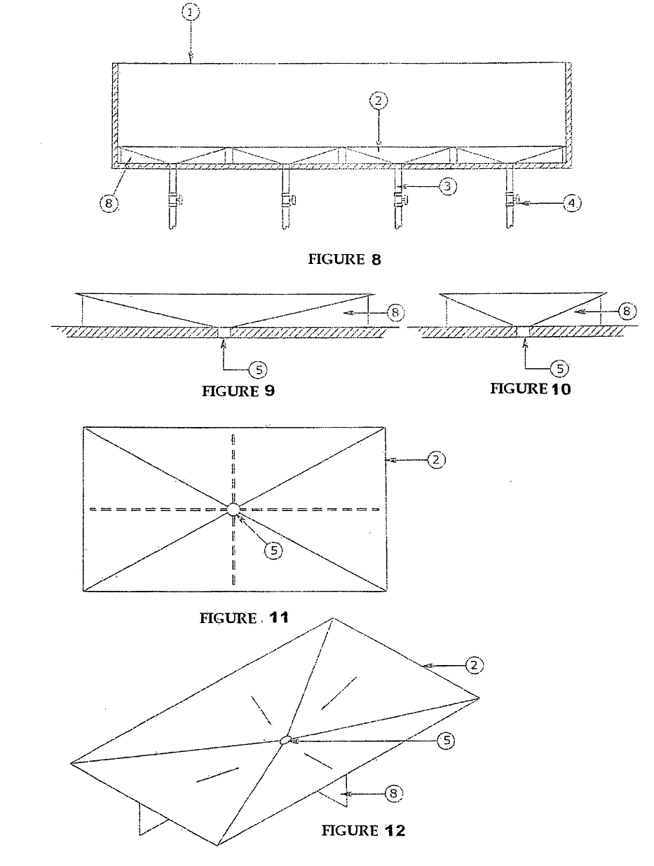

FIGS. 8 to 13 show the modifications which can be made to existing cells and cells in use, to comply with the geometry of the invention described herein.

FIG. 8 shows the distribution of 4 pyramid shaped funnels (2), their walls having a suitable sliding slope to facilitate an easy sliding motion of sludge towards the discharge duct (3), which is fitted with a safety shut-off valve (4).

Without limiting the invention, it is evident that the number of funnels to be used must be determined in situ, as the number of required funnels depends only on the length of the cell or vessel being designed or modified. There may be 2, 3, 4 or more funnels in the design, and someone skilled in the art could readily decide how many funnels should be installed to produce the sliding effect of the sludge towards the discharge duct, thus producing a continuous removal of sludge.

FIGS. 9 and 10 depict, respectively, side and front views of the pyramid shaped funnel, showing the slope or inclination of its different faces converging on the discharge opening (5), and emphasizing the support and/or bearing (8) in the base of the funnel that give stability to the funnel.

FIG. 11 shows a top view of the pyramid-shaped funnel (2) having the discharge opening (5) with its support shaded in.

FIG. 12 shows an isometric view of the pyramid-shaped funnel with its respective support (8) and discharge opening (5)

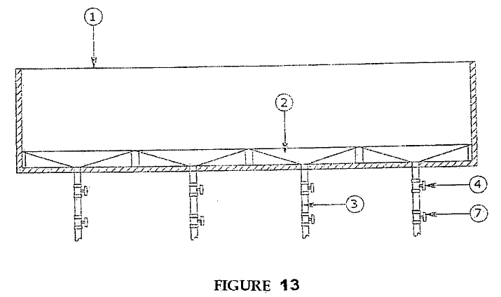

FIG. 13 shows a funnel distribution (2) identical to that presented in FIG. 8, with a discharge duct (3) and two shut-off valves in series (4) and (7).

FIGS. 8 and 13 demonstrate the channeling and removal of sludge by means of the funnels, through four perforations made in the floor of the cell, the number of required perforations depending on the number of funnels the user wishes to install.

Operational Procedure for Sludge Removal

Using the scheme shown in FIG. 1 (i.e., having a single shut-off valve), the sludge deposits as a sediment on the faces of the funnel, wherefrom it slides down towards the discharge opening (5), and accumulates in the discharge duct (3). Sludge removal or discharge is achieved by opening valve (4) and displacing the volume of sludge retained in the discharge duct (3).

Using the scheme shown in FIG. 5 (i.e., with two shut-off valves), valve (4) remains permanently open during normal cell operation, while valve (7) obviously remains closed. In this way, the solids deposited as a sediment on the walls of the funnel slide inside the discharge duct (3), accumulating there until the time of their removal.

To carry out the removal of sludge, the operator must first close valve (4) and then open valve (7) to allow the evacuation of sludge from duct (3). Once all the sludge has been evacuated from duct (3), valve (7) is closed and valve (4) is slowly opened.

An alternative procedure involves connecting duct (3) to a common pipeline or discharge manifold, which directs the sludge towards the central aisle of the tank house and discharges it into a sludge collecting container.

The continuous sludge removal procedure described herein for lead sludge or anode sludge, does not interfere with or affect in any way the normal functioning of the production process in electro-winning or electro-refining of metals.

The benefits obtained from the use of this invention are as follows:
The invention allows to remove the sludge without stopping the production process, which normally means a reduction in economic loss due to down time. The process does not cause agitation or turbulence in the sludge, which would cause contamination of the cathode surface.
The invention reduces operational costs, as less equipment and man power is required for the cleaning process.
The use of a short-circuiting frame to insulate the cells to be desludged is not necessary.
The invention allows a more efficient control of the service life of the anodes.
The invention reduces safety risks in operational procedures.

1. An electrolytic cell or modified electrolytic cell for the recovery of metals, wherein said electrolytic cell has a configuration having one or more pyramid-shaped funnels that allows the continuous extraction and removal of anode sludge or anode slimes from the bottom of the cell, said cell comprising:
a cell with a rectangular base having pyramid-shaped funnels, these pyramid shaped funnels ending in a circular discharge and evacuation point followed by a discharge duct having one or more shut-off valves.

2. An electrolytic cell or modified electrolytic cell according to claim 1, wherein said discharge duct has one shut-off valve.

3. An electrolytic cell or modified electrolytic cell according to claim 1, wherein said discharge duct has two shut-off valves and which are serially positioned.

4. An electrolytic cell or modified electrolytic cell according to claim 1, wherein said electrolytic cell has 3, 4 or more pyramid-shaped funnels in the floor or base of the cell, depending on the length of the cell.

5. An electrolytic cell or modified electrolytic cell according to claim 1 wherein said electrolytic cell has 4 or more pyramid-shaped funnels positioned inside an existing electrolytic cell or an electrolytic cell which is in use.

6. An electrolytic cell or modified electrolytic cell according to claim 5 wherein said electrolytic cell has 4 or more openings in the base of the cell, the discharge ducts with one shut-off valve and the funnels installed over the discharge ducts being installed at said 4 or more openings.

7. An electrolytic cell or modified electrolytic cell according to claim 5 wherein said electrolytic cell has 4 or more openings in the base of the cell, the discharge ducts with two shut-off valves and serially positioned and funnels installed over the discharge ducts being installed at said 4 or more openings.

8. A method for the continuous removal and extraction of anode sludge or slime using a cell according to claim 1, wherein said method comprises the following operation depending on the number of shut-off valves installed in the cell:
a) With one shut off valve, the sludge will form a sediment over the faces of the funnel, which then slides down towards the circular discharge point and accumulates in the discharge duct. The sludge removal or discharge is done by opening valve and displacing the volume of sludge retained in the discharge duct.
b) For cells with two shut-off valves, valve will remain open during the normal operation of the cell, while valve remains closed. In this way, the solids deposited as a sediment on the walls of the funnel will slide downwards into the duct and will continue to accumulate there until they are removed. To remove the sludge from the duct, valve must first be closed, and then valve is opened to allow the discharge and removal of the accumulated sludge from the duct. Once all the sludge has been completely removed from the duct, valve is closed, and valve is slowly opened.

9. A method for the continuous extraction and removal of anode sludge and slime according to claim 8, wherein optionally said duct is connected to a common pipeline or manifold which transports the sludge towards the central aisle of the tank house, where it is discharged into a sludge collecting container.
